(19) United States
(12) Patent Application Publication
(10) Pub. No.: US 2023/0175510 A1
(43) Pub. Date: Jun. 8, 2023

(54) SCROLL COMPRESSOR

(71) Applicant: LG ELECTRONICS INC., Seoul (KR)

(72) Inventors: Kyungho LEE, Seoul (KR); Jehyeon MOON, Seoul (KR)

(21) Appl. No.: 17/980,625

(22) Filed: Nov. 4, 2022

(30) Foreign Application Priority Data
Dec. 2, 2021 (KR) 10-2021-0171221

(51) Int. Cl. F04C 29/02; F04C 18/02

(52) U.S. Cl. CPC F04C 29/026; F04C 18/0215; F04C 29/025; F04C 2240/30; F04C 2240/806; F04C 2240/809

(57) ABSTRACT

A scroll compressor is provided that may include a casing having an oil storage space, a suction pipe and a discharge pipe being connected to the casing, a drive motor installed in an inner space of the casing and including a rotational shaft rotated by a generated drive force, a compression unit installed in the inner space of the casing and having a compression chamber operated by the drive motor to compress a refrigerant, an oil separator coupled to the discharge pipe, that receives refrigerant discharged after being compressed by the compression unit, separates oil from the refringent, and supplies the oil to an inside of the casing, and a subframe that rotatably supports the rotational shaft at one side of the rotational shaft. The subframe may be provided with an oil recovery flow path that extends in a radial direction and guides oil to be recovered toward the inside of the casing from the oil separator.

### CROSS-REFERENCE TO RELATED APPLICATION(S)

Pursuant to 35 U.S.C. § 119(a), this application claims the benefit of the earlier filing date and the right of priority to Korean Patent Application No. 10-2021-0171221, filed in Korea on Dec. 2, 2021, the contents of which are incorporated by reference herein in their entirety.

### BACKGROUND

### 1. Field

A scroll compressor, and more particularly, a scroll compressor that recovers oil separated through an oil separator and supplies the oil to a compression unit are disclosed herein.

### 2. Background

A scroll compressor is configured such that an orbiting scroll and a non-orbiting scroll are engaged with each other and a pair of compression chambers is formed while the orbiting scroll performs an orbiting motion with respect to the non-orbiting scroll. The compression chamber includes a suction pressure chamber formed at an outer side, an intermediate pressure chamber continuously formed toward a central portion from the suction pressure chamber while gradually decreasing in volume, and a discharge pressure chamber connected to a center of the intermediate pressure chamber. Typically, the suction pressure chamber is formed through a side surface of a non-orbiting scroll, the intermediate pressure chamber is sealed, and the discharge pressure chamber is formed through an end plate of the non-orbiting scroll.

Scroll compressors may be classified into a low-pressure type and a high-pressure type according to a path through which refrigerant is suctioned. The low-pressure type is configured such that a refrigerant suction pipe is connected to an inner space of a casing to guide a suction refrigerant of a low temperature to flow into a suction pressure chamber via the inner space of the casing. The high-pressure type is configured such that the refrigerant suction pipe is connected directly to the suction pressure chamber to guide refrigerant to flow directly into the suction pressure chamber without passing through the inner space of the casing.

On the other hand, in the case of the conventional scroll compressor, the refrigerant discharged from the inside of the compression chamber contains oil, and an oil separator is installed to separate the oil contained in the refrigerant. In addition, the oil is recovered by an oil pump operated by power generated from a drive motor to separate the oil.

In particular, it is possible to recover the oil by the oil pump by power from the drive motor through a structure connecting a trochoid pump of the compressor and an oil recovery pipe. A curved copper pipe is connected by welding, for example, to the oil separator through a shell in the oil pump. Such a copper pipe is simply applied without changing internal components of the existing compressor, and through this, an oil recovery flow path is constructed.

The oil recovery flow path including the copper pipe is designed to suction oil from an external oil separator through the power of the oil pump and recover the oil to the inside. In addition, the conventional oil recovery flow path is configured to recover the oil from the outside to an internal pump chamber through a copper pipe having a straight tube shape to the oil pump.

As the conventional oil recovery flow path structure includes the copper pipe having a straight tube shape, rigidity of the copper pipe has difficultly withstanding vibration caused by internal pressure and flow pulsation, and thus, the pipe is damaged. In addition, in order to solve the problem, the rigidity of the copper pipe is improved by using a curved tube shape. However, the structure of the copper pipe having a curved tube shape is advantageous in terms of rigidness and vibration compared to the pipe having a straight tube shape, but due to structural weakness of the thin copper pipe, deformation occurs due to a difference in rigidness when the curved copper pipe is press-fit into an oil pickup.

In addition, quality and reliability problems occurred due to loosening of a press-fitting base by an external excitation source, such as flow pulsation, and other vibration excitation sources. The problem of loosening of the press-fitting base also causes refrigerant leakage problem, causes a pressure drop between the oil recovery flow paths, reduces volumetric efficiency, causes severe vibration due to flow pulsation and other vibration excitation sources during high-speed operation, and causes additional vibration and noise.

Further, a special jig and extrusion mold are required to manufacture a copper pipe due to the geometrically complex shape of the curved pipe, and a press process cannot be used in an oil pickup and curved copper pipe press-fitting process due to the complicated shape, so that a press-fitting process is performed manually during actual mass-production assembly, causing a quality control problem. Furthermore, in a mass-production manufacturing process, a tack time increases due to an additional press-fitting process by an assembler, which reduces mass-productivity, and as an oil foaming prevention plate interference avoidance and shell connection portion is located at the bottom, an assembly process is complicated during an oil pickup and subframe fastening assembly process.

### BRIEF DESCRIPTION OF THE DRAWINGS

Embodiments will be described in detail with reference to the following drawings in which like reference numerals refer to like elements, and wherein:

FIG. 1 is a perspective view of a scroll compressor, an oil separator, and a refrigeration cycle according to an embodiment;

FIG. 2 is a cross-sectional view of a scroll compressor according to an embodiment;

FIG. 3 is an exploded perspective view of a subframe and an oil pump of a scroll compressor according to an embodiment;

FIG. 4 is an enlarged view of the scroll compressor of FIG. 2 showing a subframe and an oil pump of the scroll compressor according to an embodiment;

FIG. 5 is a plan view of a pump housing including an inner gear and an outer gear in an oil pump according to an embodiment;

FIG. 6 is a plan view of an upper surface of a pump housing in which an inner gear and an outer gear are removed in the oil pump of FIG. 5;

FIGS. 7 to 9 are plan views schematically showing a process of pumping oil in the oil pump of FIG. 5;

FIG. 10 is a cross-sectional view of a lower portion of a scroll compressor according to an embodiment;

FIG. 11 is an enlarged cross-sectional view of an oil recovery flow path provided in a subframe according to an embodiment;

FIG. 12 is a perspective view of a subframe in which an oil recovery flow path is provided according to the embodiment of FIG. 11;

FIG. 13 is a perspective view of a subframe in which an oil recovery flow path is provided according to another embodiment;

FIG. 14 is an enlarged cross-sectional view of an oil recovery flow path provided in a subframe according to the embodiment of FIG. 13;

FIG. 15 is a cut-away perspective view of a subframe in which an oil recovery flow path is provided according to still another embodiment;

FIG. 16 is a cross-sectional view of a subframe in which an oil recovery flow path is provided according to the embodiment of FIG. 15;

FIG. 17 is a cross-sectional view of a subframe in which an oil recovery flow path is provided according to still another embodiment; and

FIG. 18 is a cross-sectional view of a subframe in which an oil recovery flow path is provided according to embodiment of FIG. 17.

### DETAILED DESCRIPTION

Hereinafter, a scroll compressor according to embodiments will be described with reference to the accompanying drawings. In the following description, description of some components may be omitted to clarify features.

In addition, the term “upper side” used in the following description refers to a direction away from the support surface for supporting a scroll compressor 1 according to an implementation of the present disclosure, that is, a direction toward a motor unit when viewed based on the motor unit and a compression unit. The term “lower side” refers to a direction toward the support surface, that is, a direction toward the compression unit when viewed based on the motor unit and the compression unit.

The term “axial direction” used in the following description refers to a lengthwise (longitudinal) direction of a rotational shaft. The “axial direction” may be understood as an up and down (or vertical) direction. The term “radial direction” refers to a direction that intersects the rotational shaft.

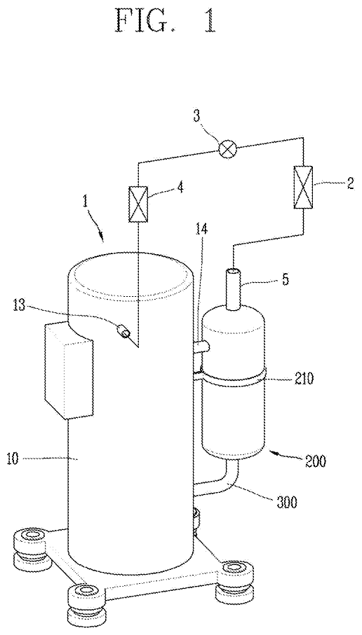

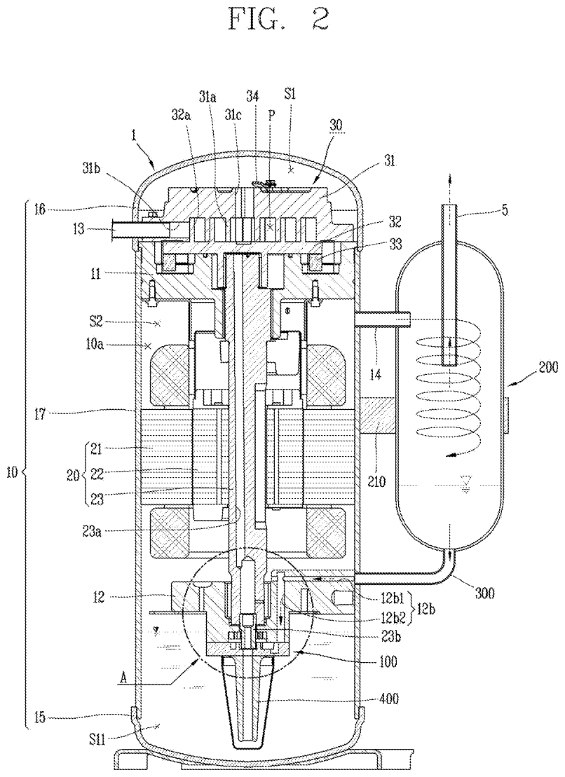

FIG. 1 is a perspective view of a scroll compressor, an oil separator, and a refrigeration cycle according to an embodiment. FIG. 2 is a cross-sectional view of the scroll compressor according to an embodiment.

Referring to FIG. 1, in a casing 10, a suction pipe 13 and a discharge pipe 14 are connected so that a compressor 1 forms a refrigeration cycle together with a condenser 2, an expander 3, and an evaporator 4. The suction pipe 13 is connected to the evaporator 4 of the refrigeration cycle, while the discharge pipe 14 is connected to an oil separator 200 to which the condenser 2 of the refrigeration cycle is connected.

The suction pipe 13 may be directly connected to a compression unit 30 so that an inner space of the casing 10 may be filled with the refrigerant at a discharge pressure, and the compression unit 30 of the casing 10 discharges the refrigerant into the inner space. Between the discharge pipe 14 of the compressor 1 and an inlet side of the condenser 2, the oil separator 200 may be installed to separate oil from the refrigerant discharged from the compressor 1 to the condenser 2 through the discharge pipe 14.

In addition, referring to FIGS. 1 and 2, the scroll compressor 1 according to an embodiment may include the casing 10 having a storage space S11, the suction pipe 13 and the discharge pipe 14 being connected to the casing 10, a drive motor 20 installed in an inner space 10a of the casing 10 and including a rotational shaft 23 rotated by a generated drive force; a compression unit 30 installed in the inner space 10a of the casing 10 and having a compression chamber P operated by the drive motor 20 to compress refrigerant; the oil separator 200 coupled to the discharge pipe 14, that receives refrigerant discharged after being compressed by the compression unit 30, separates oil, and supplies the oil to an inside of the casing 10; and a subframe 12 that rotatably supports the rotational shaft 23 from one side of the rotational shaft 23. In addition, the subframe 12 is provided with an oil recovery flow path 12b, which will be described hereinafter.

The casing 10 includes the oil storage space S11, and the suction pipe 13 and the discharge pipe 14 are connected to the casing 10. As an example, the drive motor 20 may be installed in or at a middle portion between upper and lower sides of the casing 10, and a main frame 11, an orbiting scroll 32, and a fixed scroll 31 may be sequentially installed at an upper side of the drive motor 20.

The casing 10 may include a cylindrical shell 17, an upper shell 12, and a lower shell 15. The cylindrical shell 17 may be formed in a cylindrical shape with both ends open. The upper shell 12 may be coupled to an upper end portion of the cylindrical shell 17, and the lower shell 15 may be coupled to a lower end portion of the cylindrical shell 17.

That is, both the upper and lower end portions of the cylindrical shell 17 may be coupled to the upper shell 12 and the lower shell 15, respectively, in a covering manner. The cylindrical shell 17, the upper shell 12, and the lower shell 15 which are coupled together may define the inner space 10a of the casing 10. The inner space 10a may be sealed.

The inner space 10a of the sealed casing 10 may be divided into an upper space S1, an oil storage space S11, and a lower or discharge space S2. The upper space S1 may be defined in or at an upper side of the main frame 11 and the oil storage space S11 and the discharge space S2 may be defined in or at a lower side of the main frame 11. The upper space S1 refers to a space above the compression unit 30, and the oil storage space S11 refers to a lower space of the casing 10 in which oil is accumulated.

One or a first end of the refrigerant suction pipe 13 may be coupled through a side surface of the cylindrical shell 17. More specifically, the one end of the refrigerant suction pipe 13 may be coupled through the cylindrical shell 17 in a radial direction of the cylindrical shell 17.

The refrigerant suction pipe 13 may penetrate through the cylindrical shell 17 and be directly coupled to a suction through-hole 31b of the fixed scroll 31. Accordingly, the refrigerant may be introduced into the compression chamber P through the refrigerant suction pipe 13.

An accumulator (not shown) may be coupled to the one end and the other or a second end of the refrigerant suction pipe 13. The accumulator may be connected to an outlet side of the evaporator 4 by a refrigerant pipe. Accordingly, in the refrigerant moving from the evaporator 4 to the accumulator, liquid refrigerant is separated by the accumulator, and gas refrigerant is directly suctioned into the compression chamber P through the refrigerant suction pipe 13.

The refrigerant discharge pipe 14 which communicates with the inner space 10a of the casing 10 may be coupled through the cylindrical shell 17. Accordingly, the refrigerant discharged from the compression unit 30 to the inner space 10a of the casing 10 may be discharged to the oil separator 200 through the refrigerant discharge pipe 14.

In the inner space of the casing 10, the main frame 11 and the subframe 12 supporting the rotational shaft 23 of the drive motor 20, and at the same time, supporting the compression unit 30 may be fixed to and installed on both sides of the drive motor 20. The drive motor 20 may be installed in the inner space 10a of the casing 10 and include the rotational shaft 23 that is rotated by a generated drive force.

As the drive motor 20, a constant speed motor having a constant rotation speed may be used, but an inverter motor having a variable rotation speed may be used in consideration of multi-functionalization of a refrigeration machine to which the compressor 1 is applied.

Also, the drive motor 20 may include a stator 21 fixed to an inner circumferential surface of the casing 10, a rotor 22 rotatably disposed inside of the stator 21, and the rotational shaft 23 coupled to a center of the rotor 22 to transmit the rotational force from the drive motor 20 to the compression unit 30. The rotational shaft 23 may be supported by the main frame 11 and the subframe 12. An oil flow path 23a may be provided through the rotational shaft 23 in the axial direction, and an oil pump 100 described hereinafter may be installed at a lower end of the oil flow path 23a, that is, at a lower end of the rotational shaft 23 to pump oil toward the oil flow path 23a.

The oil pump 100 will be described hereinafter.

The compression unit 30 is installed in the inner space 10a of the casing 10, and has the compression chamber P operated by the drive motor 20 to compress the refrigerant. As will be described hereinafter, the compression unit 30 may include a fixed scroll 31 and an orbiting scroll 32, and the compression chamber P may be formed by an orbiting wrap 31a of the fixed scroll 31 and an orbiting wrap 32a of the orbiting scroll 32.

As shown in FIG. 2, the compression unit 30 may include the fixed scroll 31 coupled to the main frame 11, the orbiting scroll 32 engaged with the fixed scroll 31 to form a pair of two compression chambers P that move continuously, an Oldham ring 33 installed between the orbiting scroll 32 and the main frame 11 to induce an orbiting motion of the orbiting scroll 32, and a check valve 34 installed to open and close a discharge port 31c of the fixed scroll 31 to block a backflow of a discharge gas discharged through the discharge port 31c. The fixed scroll 31 and the orbiting scroll 32 may have a fixed wrap 31a and an orbiting wrap 32a engaged with each other to form the compression chamber P, respectively, in a spiral shape. The suction pipe 13 that guides the refrigerant from the refrigeration cycle may be directly connected to suction port 31b of the fixed scroll 31, and the discharge port 31c of the fixed scroll 31 may communicate with the upper space S1 of the casing 10.

In the scroll compressor 1 according to an embodiment, when power is applied to the drive motor 20, the rotational shaft 23 rotates together with the rotor 22 and transmits a rotational force to the orbiting scroll 32. The orbiting scroll 32, which has received the rotational force, rotates by an eccentric distance from the upper surface of the main frame 11 by the Oldham ring 33, to form a pair of compression chambers P continuously moving between the fixed wrap 31a of the fixed scroll 31 and the orbiting wrap 32a of the orbiting scroll 32, and while the compression chambers P are moving to the center by the continuous orbiting motion of the orbiting scroll 32, a volume thereof is reduced to compress the refrigerant being suctioned.

A series of processes in which the compressed refrigerant is continuously discharged to the upper space S1 of the casing 10 through the discharge port 31c of the fixed scroll 31, and then moves to the lower space S2 of the casing 10 and moves to the oil separator 200 through the discharge pipe 14, so that separated refrigerant is discharged to the condenser 2 of the refrigeration cycle, and the refrigerant discharged to the condenser 2 of the refrigeration cycle passes through the expander 3 and the evaporator 4 and is suctioned into the compressor 1 again through the suction pipe 13 is repeated.

The oil separated by the oil separator 200 flows to the inside of the casing 10 through oil recovery pipe 300 and accumulates in the oil storage space S11 through the oil recovery flow path 12b or is supplied to the compression unit 30, for example, through the oil flow path 23a of the rotational shaft 23 for lubrication. The flow of the oil introduced into the casing 10 will be described hereinafter along with the description of the oil recovery flow path 12b and the oil pump 100 of the various embodiments described hereinafter. The oil separator 200 may be coupled to the discharge pipe 14, receive the refrigerant compressed and discharged from the compression unit 30 to separate the oil, and supply the oil to the inside of the casing 10.

The scroll compressor 1 according to an embodiment may further include an oil recovery pipe 300. The oil separator 200 may be installed outside of the casing 10, and or a first one end of the oil recovery pipe 300 that guides the oil separated by the oil separator 200 to the oil pump 100 may be connected to a lower end of the oil separator 200. In addition, the other or a second end of the oil recovery pipe 300 may be coupled to an oil recovery hole 11b of the casing 10 from the outside of the casing 10.

The oil separator 200 may have a container-like shape having a sealed inner space, as shown in FIGS. 1 and 2, and be disposed side by side on one side of the casing 10. The oil recovery pipe 300 may be connected to the oil separator 200 and supported by the casing 10, or the oil separator 200 may be supported, while being wrapped by a separate support 210, such as a clamp fixed to the casing 10.

As shown in FIG. 2, the discharge pipe 14 may be connected to an upper side wall surface of the oil separator 200 so that the refrigerant discharged from the inner space of the casing 10 may be guided to the inner space of the oil separator 200, a refrigerant pipe 5 may be connected to an upper end of the oil separator 200 so that the refrigerant separated from oil in the inner space of the oil separator 200 moves to the condenser 2 of the refrigeration cycle, and the oil recovery pipe 300 may be coupled to a lower end of the oil separator 200 so that the oil separated from the inner space of the oil separator 200 may be guided to be recovered into the casing 10. The oil recovery pipe 300 may be a metal pipe having a predetermined rigidity so as to stably support the oil separator 200, and may be bent at an angle at which the oil separator 200 is disposed to be parallel to the compressor casing 10 to attenuate vibration of the compressor.

Various methods for separating oil may be applied. For example, a mesh screen may be installed in the inner space of the oil separator 200 so that the refrigerant and oil are separated, or the discharge pipe 14 may be twisted with respect to an axial center of the oil separator 200 so that the refrigerant rotates in a cyclone form and the relatively heavy oil is separated.

The subframe 12 rotatably supports the rotational shaft 23 from one side of the rotational shaft 23. FIG. 2 shows the subframe 12 rotatably supporting the rotational shaft 23 from a lower side of the rotational shaft 23.

Oil recovery flow path 12b may be formed in the subframe 12. The oil recovery flow path 12b may include a radial flow path. The oil separated from the oil separator 200 may be provided to one end of the oil recovery flow path 12b in contact with the inner periphery of the casing 10. The oil recovery flow path 12b may enable recovery of oil to the oil storage space S11 or the rotational shaft 23.

The subframe 12 may be provided with frame support portion or support 12a. The frame support 12a may extend radially from the main body of the subframe 12, and be coupled to the inner periphery of the casing 10 to support the subframe 12 with respect to the casing 10.

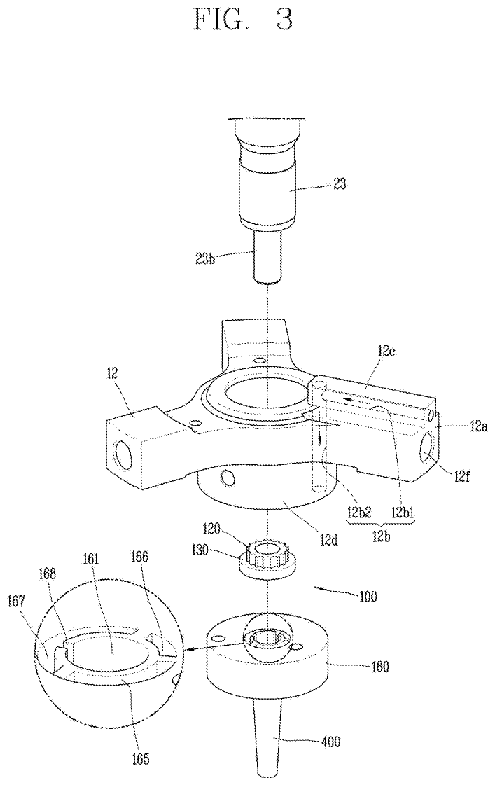

Referring to FIG. 3, an example is shown in which three frame supports 12a are provided, and each frame support 12a extends radially from a main body of the subframe 12. For stable support on the inner periphery of the casing 10, the frame supports 12a may be arranged at equal intervals in the circumferential direction.

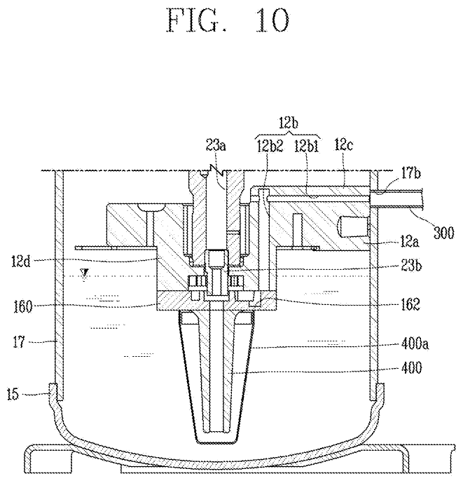

FIG. 10 is a cross-sectional view of a lower portion of the scroll compressor according to an embodiment. FIG. 11 is an enlarged cross-sectional view of an oil recovery flow path according to an embodiment provided in the subframe 12, and FIG. 12 is a perspective view of the subframe in which the oil recovery flow path is provided.

Hereinafter, the oil recovery flow path 12b according to an embodiment will be described with reference to FIGS. 10 to 12.

The oil recovery flow path 12b may include first and second oil flow paths 12b1 and 12b2. The first flow path 12b1 may be provided in a radial direction in the frame support 12a to receive oil provided from the oil separator 200.

The second flow path 12b2 may intersect the first flow path 12b1, and may enable the oil provided from the first flow path 12b1 to be provided to the oil storage space S11 or the rotational shaft 23. Of course, the second flow path 12b2 may also provide the oil provided from the first flow path 12b1 to an oil pump. The second flow path 12b2 may be formed in a main body of the subframe 12. An outlet of the second flow path 12b2 may be open toward the oil storage space S11 to provide oil to the oil storage space S11.

As shown in FIGS. 10 to 12, an example in which the first flow path 12b1 is provided in a right frame support 12a, among three frame supports 12a, in a radial direction from the frame support 12a, and the second flow path 12b2 is provided from a top of the subframe 12 to a bottom to intersect the first flow path 12b is illustrated. In FIGS. 10 and 11, an example in which a left or first lateral end of the first flow path 12b1 communicates with the second flow path 12b2 and a right or second lateral end of the first flow path 12b1 is in contact with the oil recovery hole 11b of the casing 10 is illustrated. The oil recovery hole 11b may be a hole to which the oil recovery pipe 300 through which the oil separated by the oil separator 200 flows is coupled.

A rib 12c may protrude from one surface of the frame support 12a of the subframe 12, and the protruding rib 12c may extend in a radial direction. In this case, the first flow path 12b1 may be formed in the radial direction inside of the rib 12c.

Referring to FIGS. 11 and 12, an example is shown in which the rib 12c protrudes from an upper surface of the frame support 12a on the right side of the subframe 12, and an example is shown in which the rib 12c extends along the radial direction and the first flow path 12b1 is formed in the radial direction in which the rib 12c extends inside of the rib 12c. In addition, an example is shown in which the second flow path 12b2 is also formed in a direction intersecting the first flow path 12b1 so that oil flows in the radial direction through the first flow path 12b1 and then flows downward through the second flow path 12b2.

The oil separated by the oil separator 200 passes through the oil recovery pipe 300, passes through the oil recovery hole 11b, passes through the first flow path 12b1, and flows into the oil pump 100 or the oil storage space S11 described hereinafter through the second flow path 12b2. Through the first and second flow paths 12b1 and 12b2 formed in the subframe 12 without using the existing copper pipe, a problem in which a press-fitting band is loosened by the existing copper pipe and a problem in which the mass-production process is complicated may be solved, thereby improving volumetric efficiency and being advantageous for vibration. In addition, as the existing copper pipe is not required, material costs may be reduced.

An example is shown in which the subframe 12 having the oil recovery flow path 12b according to an embodiment includes a coupling portion 12f coupled to the inner periphery of the casing 10, and a fastening member, such as a screw, for example, may be coupled to the coupling portion 12f to couple the coupling portion 12f to the inner periphery of the casing 10.

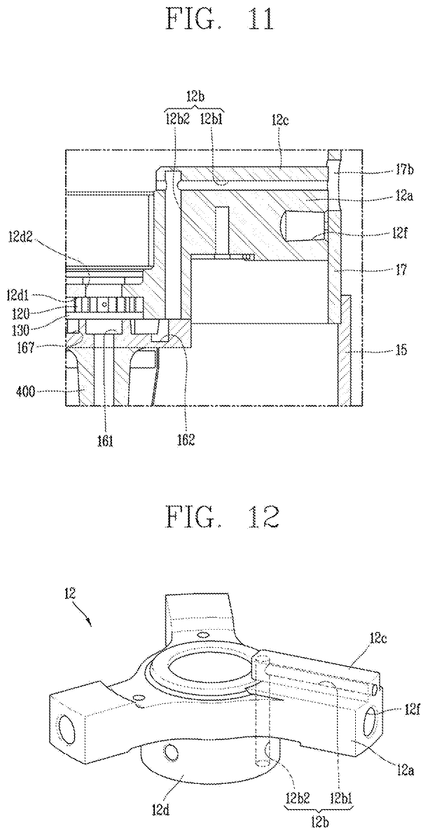

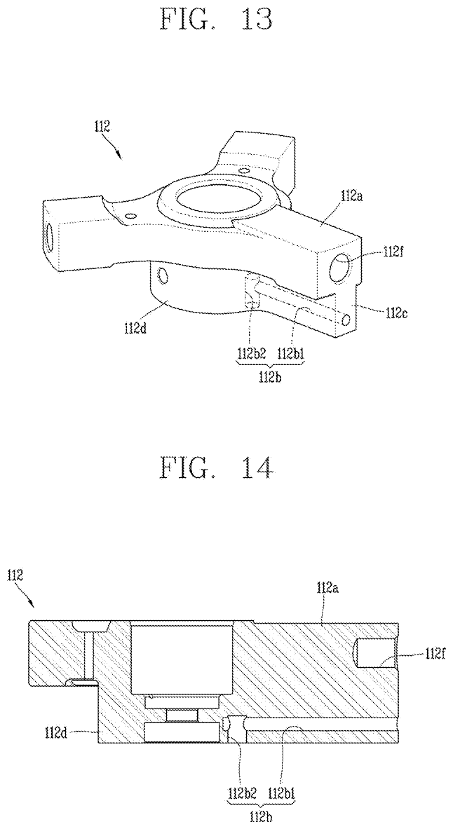

FIG. 13 is a perspective view of a subframe in which an oil recovery flow path according to another embodiment is provided. FIG. 14 is an enlarged cross-sectional view of the oil recovery flow path of FIG. 13 provided in the subframe.

Hereinafter, oil recovery flow path 112b according to another embodiment will be described with reference to FIGS. 13 and 14.

As shown in FIG. 13, the rib 112c may protrude from a lower surface of the frame support 12a of the subframe 112. FIG. 13 shows an example in which the rib 112c protrudes to extend in a radial direction from the lower surface of the frame support 12a of the subframe 112.

In addition, as shown in FIGS. 13 and 14, a first flow path 112b1 of the subframe 112 is formed in the rib 112c in a radial direction, and an example in which it extends downward through the second flow path 112b2 is shown. Compared to the example in which the rib 12c is on the upper surface of the frame support 112a, when the rib 112c is on the lower surface of the frame support 112a, the second flow path 112b2 has a relatively short length.

The oil separated by the oil separator 200 passes through the oil recovery pipe 300, passes through the oil recovery hole 11b to pass through the first flow path 112b1, and also passes through the second flow path 112b2 to be supplied to the compression unit 30, for example, through the oil pump 100 or introduced into the oil storage space S11. In the oil recovery flow path 112b according to this embodiment, as the second flow path 112b2 is formed on the rib 112c of the lower surface of the frame support 112a, the second flow path 112b2 is shorter than that of the previous embodiment, and therefore, flow resistance and loss are reduced by the short flow path.

An example is shown in which the subframe 112 having the oil recovery flow path 112b according to this embodiment includes a coupling portion 112f coupled to the inner periphery of the casing 10, and a fastening member may be coupled to the coupling portion 112f and the coupling portion 112f may be coupled to the inner periphery of the casing 10.

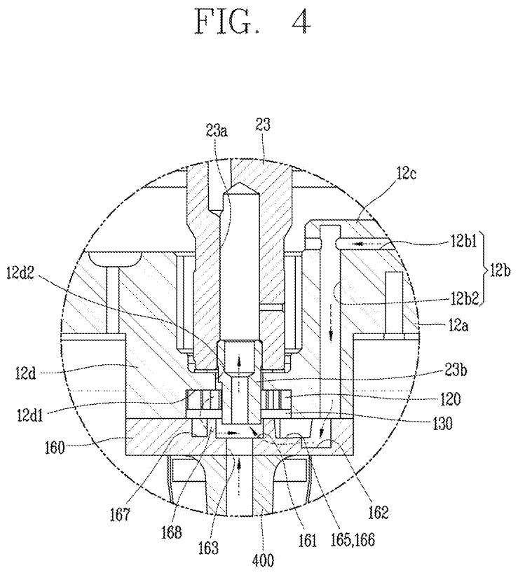

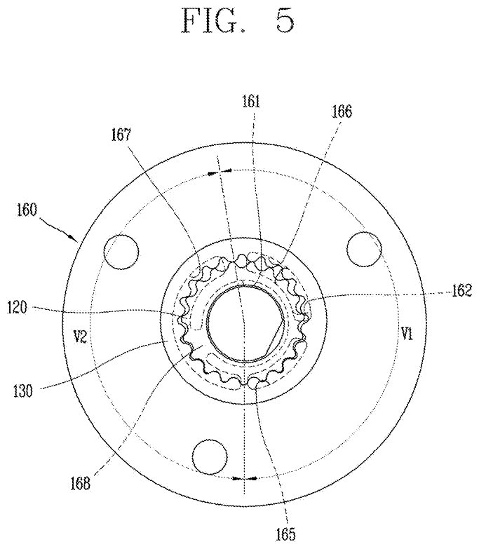

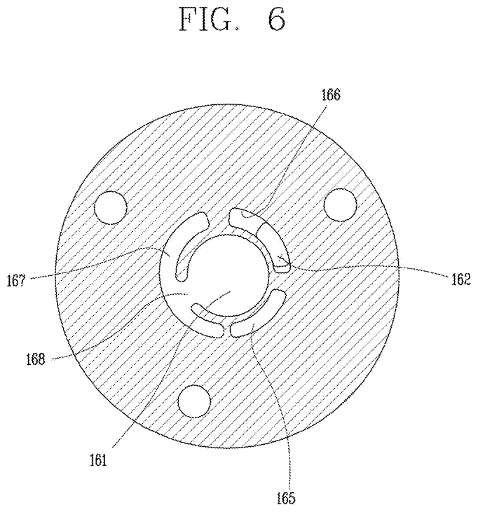

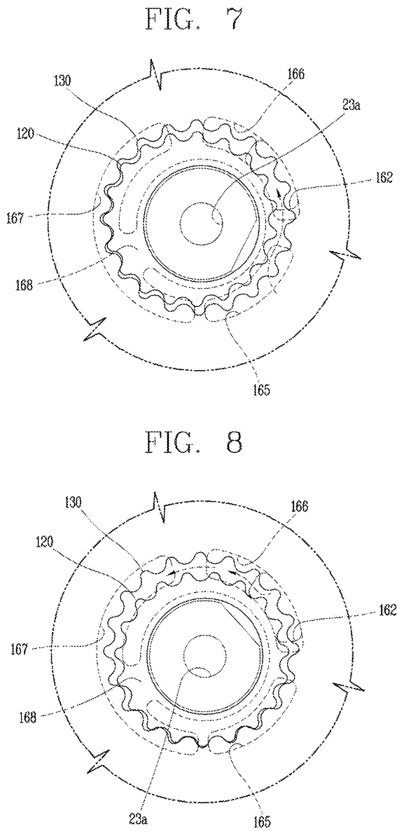

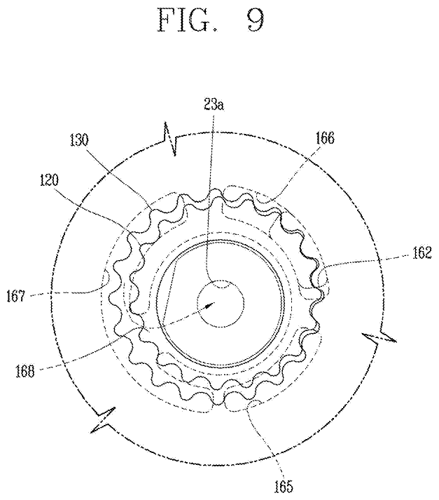

FIG. 3 is an exploded perspective view showing the subframe and the oil pump of the scroll compressor according to an embodiment. FIG. 4 is an enlarged view of A of FIG. 2 showing the subframe and the oil pump of the scroll compressor according to an embodiment. FIG. 5 is a plan view showing a pump housing including an inner gear and an outer gear in the oil pump. FIG. 6 is a plan view showing an upper surface of the pump housing in which the inner gear and the outer gear are removed from the oil pump according to FIG. 5. FIGS. 7 to 9 are plan views schematically showing a process of pumping oil in the oil pump according to FIG. 5.

As described above, the scroll compressor 1 according to an embodiment may include the oil pump 100. Hereinafter, the oil pump 100 will be described with reference to FIGS. 3 to 9.

The oil pump 100 recovers the oil separated by the oil separator 200, while being operated by a rotational force of the rotational shaft 23 and pumps the oil filling the inner space of the casing 10 to supply the oil to the oil flow path 23a of the rotational shaft 23, and the oil supplied to the oil flow path 23a cools the drive motor 20, while lubricating the compression unit 30. The oil pump 100 may be installed at a lower end of the rotational shaft 23. Of course, the oil pump 100, in addition to the oil separated by the oil separator 200, may pump the oil filling the inner space of the casing 10 and supply the oil to the compression unit 30, for example, through the oil flow path of the rotational shaft 23.

The oil pump 100 may be a volumetric pump that pumps oil, while varied in volume, like a trochoidal gear pump. The oil pump 100 may include pump housing 160, inner gear 120, and outer gear 130.

The pump housing 160 may be coupled to a main body of the subframe 12, and a pumping space may be provided in the pump housing 160. The pumping space may be understood as a space for accommodating oil to be pumped so as to be provided to a bearing through the rotational shaft 23.

Referring to FIG. 3, an example is shown in which the pump housing 160 has a flat cylindrical shape and is coupled to a lower end of a main body 12d of the subframe 12. However, embodiments are not necessarily limited to this configuration, and the pump housing 160 may have any other shape than the cylindrical shape as long as a pumping space 12d1 is provided and the inner and outer gears 120 and 130 are installed therein.

The inner gear 120 may be rotatably disposed in the pumping space 12d1 of main body 12d of the subframe 12, and be coupled to the rotational shaft 23 to perform eccentric rotation. The outer gear 130 may be rotatably disposed in the pumping space 12d1 to be engaged with the inner gear 120 to change a volume of the pumping space 12d1. Referring to FIGS. 3 and 5, the outer gear 130 may have a gear shape therein to be engaged with the inner gear 120.

In addition, the pump housing 160 may be provided with a recovery inlet 162. The recovery inlet 162 may be configured to communicate with the oil recovery flow path 12b provided in the subframe 12. In addition, the recovery inlet 162 allows the oil recovered from the oil recovery flow path 12b to be introduced into the pumping space 12d1 of the pump housing 160.

An example is shown in FIG. 4 in which the recovery inlet 162 has an “L” shape; however, embodiments are not necessarily limited to this structure, and the recovery inlet 162 may have any other shape as long as the recovery inlet 162 has a structure in which the oil recovered from the oil recovery flow path 12b flows into the pumping space 12d1 of the pump housing 160. For example, the recovery inlet 162 may be formed with only a horizontal structure communicating with a groove at an upper portion of the pump housing 160.

An example is shown in which a suction port 163 is provided in the axial direction to communicate with the oil suction pipe 400. However, the suction port 163 may have any other shape as long as the suction port 163 has a structure in which oil suctioned from the oil suction pipe 400 flows into the pumping space 12d1 of the pump housing 160.

The oil suction pipe 400 may be formed so that an inlet end thereof may be immersed in the oil filling the casing 10. In addition, a blocking member 400a that accommodates the oil suction pipe 400 to block intrusion of foreign substances may be further installed outside of the oil suction pipe 400.

In addition, a suction guide groove 165 that communicates with the suction port 163 may be provided in the pump housing 160 to guide suction of oil suctioned through the suction port 163, and a discharge guide groove 167 may be provided on an opposite side of the suction guide groove 165. A discharge slit 168 may be provided on an inner wall of the discharge guide groove 167 to communicate with a communication groove 161.

The variable volume formed by the inner gear 120 and the outer gear 130 includes a suction volume portion V1 and a discharge volume portion V2. As shown in FIG. 5, the suction volume portion V1 is provided so that the volume gradually increases along a rotational direction of the inner gear 120 from a starting end of the first suction guide groove 165 to an end of the second suction guide groove 166, and the discharge volume portion V2 is connected to the suction volume portion V1 and is provided so that the volume decreases along the rotational direction of the inner gear 120 from a starting end to an end of the discharge guide groove 167. A through-hole 12d2 may be formed in the main body 12d of the subframe 12 facing the pump housing 160 so that a pin portion 23b of the rotational shaft 23 passes therethrough.

An oil supply hole (not shown) for injecting oil into the inner space of the compressor casing 10 may be formed in a lower half of the compressor casing 10. The oil supply hole may be a uniform hole that connects a plurality of compressors with each other in order to match an oil level height of each compressor when a plurality of compressors is provided.

In the scroll compressor 1 according to embodiments disclosed herein, a process of recovering oil separated from the oil and the refrigerant of the casing 10 using the oil pump 100 and supplying the oil to the compression unit 30 is as follows.

That is, as the inner gear 120 of the oil pump 100 is coupled to the rotational shaft 23 and rotates eccentrically, the suction volume portion V1 and the discharge volume portion V2 are formed between the inner gear 120 and the outer gear 130. As the recovery inlet 162 and the suction port 163 communicate with the suction volume portion V1, as shown in FIG. 4, the oil separated from the oil separator 200 flows into the recovery guide groove 166 through the recovery inlet 162, by passing through the oil recovery flow path 12b through oil recovery pipe 300, while oil filling a bottom side of the casing 10 flows into the suction guide groove 165 through the suction port 163 through the oil suction pipe 400. The oil introduced into the recovery guide groove 166 is contained in the suction volume portion V1 and flows into the suction guide groove 165 over the partition wall, and the oil introduced into the suction guide groove 165 moves from the suction volume portion V1 to the discharge volume portion V2.

Also, the oil that has moved to the discharge volume V2 flows into the discharge guide groove 167, the oil that flows into the discharge guide groove 167 flows into the communicating groove 161 through the discharge slit 168 provided on an inner peripheral wall of the discharge guide groove 167, and the oil that flows into the communicating groove 161 is suctioned into the oil flow path 23a of the rotational shaft 23. A process by which the oil suctioned into the oil flow path 23a is pushed up through the oil flow path 23a and suctioned upward by a centrifugal force of the oil flow path 23a, and a portion thereof is supplied to each bearing surface, while the rest is scattered from an upper end and flows into the compression unit 30 is repeated.

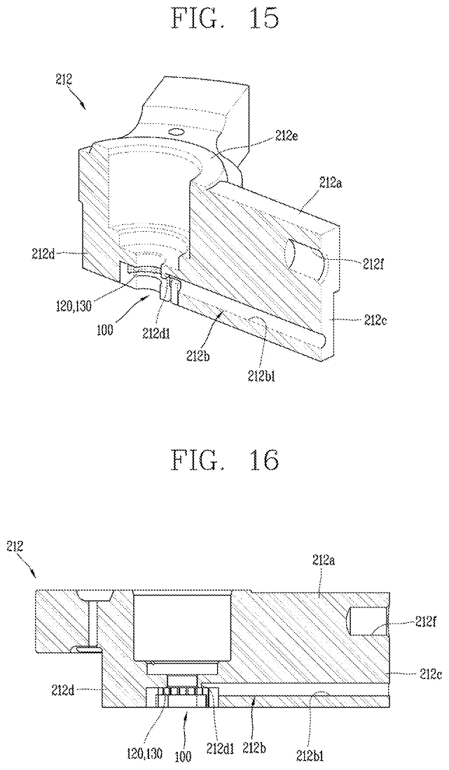

FIG. 15 is a cut-away perspective view of a subframe in which an oil recovery flow path according to still another embodiment is provided. FIG. 16 is a cross-sectional view of the subframe in which the oil recovery flow path of FIG. 15 is provided.

Oil recovery flow path 212b according to this embodiment will be described hereinafter. The oil recovery flow path 212b of this embodiment may be understood as an oil recovery flow path directly introduced into the oil pump 100 described above.

The oil recovery flow path 212b may include a direct flow path 212b1. The direct flow path 212b1 may extend in a horizontal direction from a rib 212c provided on a lower surface of frame support 212a. In addition, the oil recovery pipe 300 outside of the casing 10 may extend downwardly to a position at which the oil recovery flow path 212b of this embodiment is provided and communicate with the oil recovery flow path 212b.

The oil recovery flow path 212b may communicate with a pumping space 212d1 to supply oil to the pumping space 212d1. The oil recovery flow path 212b may include the direct flow path 212b1 to directly recover the oil separated from the oil separator 200 into the pumping space 212d1.

For example, the direct flow path 212b1 may extend parallel to a ground in a radial direction at a point at which the inner gear 120 and the outer gear 130 are provided. As the oil recovery flow path 212b provides the oil directly separated to the pumping space 212d1 including the direct flow path 212b1, an oil pump direct oil supply structure in which the oil recovered into the casing 10 is directly supplied to the oil pump without passing through another flow path may be provided.

The rib 212c may protrude from one surface of the frame support 212a of the subframe 212, and the protruding rib 212c may extend in the radial direction. For example, the rib 212c may be formed on a lower surface of the subframe 212. The direct flow path 212b1 may extend parallel to the ground in the radial direction from the rib 212c.

FIGS. 15 and 16 show an example in which the rib 212c is located on the lower surface of the frame support 212a of the subframe 212 and the direct flow path 212b1 is located in the rib 212c in the left-right or lateral direction so as to extend parallel to the ground. By forming the oil pump direct oil supply structure in which the oil recovery flow path 212b is directly supplied to the oil pump 100 without passing through another flow path, compared to the previous embodiments, flow resistance and loss is reduced by the directly supplied flow path and the oil separated from the oil separator 200 is directly supplied to the oil pump 100.

An example is shown in which the subframe 212 having the oil recovery flow path 212b of this embodiment has a coupling portion 212f coupled to the inner periphery of the casing 10. A fastening member, such as a screw, is coupled to the coupling portion 212f and the coupling portion 212f is coupled to the inner periphery of the casing 10.

FIG. 17 is a cross-sectional view of a subframe in which an oil recovery flow path according to yet another embodiment is provided. Oil recovery flow path 312b according to this embodiment will be described with reference to FIG. 17.

The oil recovery flow path 312b of this embodiment may be understood as an oil recovery flow path by which oil may be recovered to the oil storage space S11 at the same time in addition to the structure directly flowing into the oil pump 100, which is the structure described above in the oil recovery flow path of FIG. 15.

The oil recovery flow path 312b of this embodiment may include a direct flow path 312b1, and a cross flow path 312b2 connected in a direction intersecting the direct flow path 312b1 from the direct flow path 312b1 so that the oil separated from the oil separator 200 is directly recovered to the pumping space 312d1.

FIG. 17 shows an example in which the direct flow path 312b1 extends in the left-right or lateral direction parallel to the ground, and the left side of the direct flow path 312b1 communicates with the oil pump. In addition, FIG. 17 shows an example of the cross flow path 312b2 extending downward at a point spaced apart from the oil pump on the left side of the direct flow path 312b1.

Like the oil recovery flow path 12b of FIG. 15, the oil recovery flow path 312b of this embodiment includes direct flow path 312b1 and provides directly separated oil directly to the pumping space of the oil pump 100, so that an oil pump direct oil supply structure in which the oil recovered into the casing 10 is directly supplied to the oil pump 100 without passing through another flow path may be provided. At the same time, the oil recovery flow path 312b of this embodiment may also recover oil in a downward direction from the direct flow path 312b1 by the cross flow path 312b2 formed to communicate in a direction intersecting the direct flow path 312b1, thereby forming a structure in which it is possible to directly recover oil to the oil pump, and at the same time to recover oil into the oil storage space S11.

An example is shown in which the subframe 312 having the oil recovery flow path 312b of this embodiment includes a coupling portion 312f coupled to the inner periphery of the casing 10. A fastening member, such as a screw, is coupled to the coupling portion 312f and the coupling portion 312f may be coupled to the inner periphery of the casing 10.

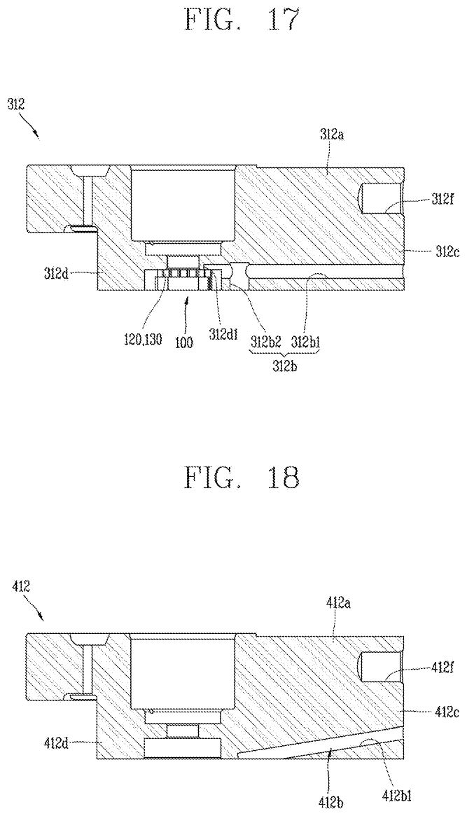

FIG. 18 is a cross-sectional view of a subframe in which an oil recovery flow path according to yet another embodiment is provided. Oil recovery flow path 412b of this embodiment will be described with reference to FIG. 18.

The oil recovery flow path 412b of this embodiment may include an oblique flow path 412b1 configured in a diagonal structure. FIG. 19 shows an example in which the oblique flow path 412b1 is provided in an oblique direction from an upper right to a lower left in the drawing.

In addition, the oil recovery flow path 412b of this embodiment may extend in an oblique direction from the rib 412c formed on a lower surface of the frame support portion. However, even in the case of this embodiment, although the oil recovery flow path 412b is formed in an oblique direction on a longitudinal section of FIG. 18, it should be noted that, like the previous embodiments, when viewed from above, the oil recovery flow path 412b is formed in a circumferential direction from a center of the rotational shaft 23, that is, in a radial direction.

In addition, the oil recovery pipe 300 outside of the casing 10 may also extend downwardly to a position at which the oil recovery flow path 412b of this embodiment is provided, to form a structure communicating with a right end of the oil recovery flow path 412b.

An example is shown in which the subframe 412 having the oil recovery flow path 412b of this embodiment includes a coupling portion 412f coupled to the inner periphery of the casing 10. A fastening member, such as a screw, may be coupled to the coupling portion 412f and the coupling portion 412f may be coupled to the inner periphery of the casing 10.

The oil recovery flow path 412b of this embodiment may form a flow path of a shorter distance than a structure (oil recovery flow paths 12b, 112b, and 312b of the previous embodiments) in which oil flows by the plurality of flow paths formed in the oblique structure, and it is possible to recover oil due to its own weight even when separate power is not required. In addition, the oil recovery flow path 412b having an oblique structure has an advantage in that it requires less processing man-hours compared to other embodiments in which two flow paths are provided.

In the scroll compressor according to embodiments, as the oil recovery flow path is formed in the subframe, the conventional unnecessary copper pipe may not be used, thereby improving volumetric efficiency. In addition, as the oil recovery flow path is formed in the subframe, the oil pump recovery structure in which a vibration excitation source is removed by not using the existing copper pipe may be applied, thereby reducing vibration and noise.

Further, the scroll compressor according to embodiments may be manufactured through a simple process during mass-production as the oil recovery flow path is formed of the first and second flow paths intersecting each other at the subframe. Furthermore, by providing ribs at the upper and lower ends of the of the subframe without press-fitting an existing pipe, it is possible to recover oil by utilizing the existing configuration.

In the scroll compressor according to embodiments, a problem due to the shape of a curved pipe when manufacturing the existing copper pipe does not arise. In addition, the scroll compressor according to embodiments simplifies the assembly process of press-fitting the existing copper pipe by configuring an oil recovery flow path in the subframe, thereby reducing tack time, improving mass-production, and reducing manufacturing costs to have price competitiveness.

The scroll compressor according to embodiments solves the problem of thermal deformation of the copper pipe and the problem of water leakage in a press-fitting portion due to the structure in which the oil recovery flow path is provided in the subframe, without using the existing copper pipe. In addition, due to the direct flow path provided to be parallel to the ground so that the oil provided from the oil separator may be directly provided to the oil pump, flow path resistance and loss are reduced by the directly supplied flow path, and the oil pump direct oil supply structure in which oil recovered into the casing is directly supplied to the oil pump without passing through another flow path may be provided.

The scroll compressor described above is not limited to the configuration and method of the embodiments described above, and all or some of the embodiments may be selectively combined so that various modifications may be made.

Therefore, embodiments disclosed herein provide a scroll compressor having an oil pump recovery structure that may be manufactured through a simple process during mass-production. Embodiments disclosed herein further provide a scroll compressor capable of improving volumetric efficiency and reducing vibration and noise by enabling an oil pump recovery structure to be applied without using a conventional copper pipe. Embodiments disclosed herein furthermore provide a scroll compressor capable of implementing a recovery flow path connected to an oil pump housing in a subframe structure existing in an internal oil pump assembly.

Embodiments disclosed herein provide a scroll compressor having a structure capable of improving a quality problem that have occurred due to the use of existing complex components. Embodiments disclosed herein also provide a scroll compressor having a structure capable of simplifying an assembly process and reducing material cost by reducing the number of components to be used.

Embodiments disclosed herein provide a scroll compressor having a structure capable of solving a problem of an additional decrease in volumetric efficiency or an occurrence of vibration caused by leakage of a refrigerant due to loosening of a press-fitting base. Embodiments disclosed herein additionally provide a scroll compressor having a structure that enables the recovery of oil by utilizing a configuration existing therein without press-fitting a pipe.

Embodiments disclosed herein provide a scroll compressor having a structure capable of reducing material costs for mass-production by reducing the number of components and improving price and quality competitiveness by simplifying manufacturing and a process. Embodiments disclosed herein provide a scroll compressor having a structure capable of solving a problem of thermal deformation of a copper pipe and resultant water leakage problem in a press-fitting portion by not using the existing copper pipe. Embodiments disclosed herein also provide a scroll compressor having an oil pump direct oil supply structure in which oil recovered into a casing is directly supplied to an oil pump without passing through another flow path.

Embodiments disclosed herein provide a scroll compressor that may include a casing having an oil storage space, a suction pipe and a discharge pipe being connected to the casing; a drive motor installed in an inner space of the casing and including a rotational shaft rotated by a generated drive force; a compression unit installed in the inner space of the casing and having a compression chamber operated by the drive motor to compress refrigerant; an oil separator coupled to the discharge pipe, that receives refrigerant discharged after being compressed by the compression unit, separates oil, and supplies the oil to an inside of the casing; and a subframe that rotatably supports the rotational shaft from one side of the rotational shaft. The subframe may be provided with a frame support portion (frame support) extending in a radial direction and coupled to and supported by an inner periphery of the casing, and the frame support portion may include an oil recovery flow path provided in a radial direction and that guides oil to be recovered toward the inside of the casing from the oil separator. Accordingly, in the scroll compressor according to embodiments, as the oil recovery flow path is formed in the subframe, the conventional unnecessary copper pipe may not be used, thereby improving volumetric efficiency. In addition, as the oil recovery flow path is formed in the subframe, the oil pump recovery structure in which a vibration excitation source is removed by not using the existing copper pipe may be applied, thereby reducing vibration and noise.

The subframe may be provided with the frame support extending in a radial direction and coupled to and supported by the inner periphery of the casing, and the oil recovery flow path may include a first flow path formed in the radial direction at the frame support portion and receiving oil provided from the oil separator, and a second flow path formed to intersect the first flow path and having an outlet opened toward the oil storage space to enable the oil provided from the first flow path to be provided to the oil storage space. Accordingly, the scroll compressor according to embodiments may be manufactured through a simple process during mass-production as the oil recovery flow path is formed of the first and second flow paths intersecting each other at the subframe.

A rib may protrude from one surface of the frame support portion. The rib may extend in a radial direction, and the first flow path may be provided in a radial direction inside of the rib. One surface of the frame support portion may be coupled to the inner periphery of the casing, and the first flow path may penetrate through one surface of the frame support portion. In addition, the rib may protrude from an upper surface or a lower surface of the frame support portion.

According to embodiments disclosed herein, the scroll compressor may further include an oil pump that recovers the oil separated from the oil separator, while operated by the rotational force of the rotational shaft, and pumping the oil filling the inner space of the casing to supply the oil to the oil flow path of the rotational shaft. The oil pump may include a pump housing coupled to one surface of the subframe and having a pumping space; an inner gear rotatably disposed in the pumping space of the pump housing and coupled to the rotational shaft for eccentric rotation; and an outer gear rotatably disposed in the pumping space to be engaged with the inner gear to change a volume of the pumping space. The oil recovery flow path may communicate with the pumping space.

The oil recovery flow path may include a direct flow path provided to be parallel with a ground in the pumping space to directly provide the oil provided from the oil separator to the pumping space. Due to the direct flow path formed to be parallel to the ground to directly provide the oil provided from the oil separator to the oil pump, an oil pump direct oil supply structure in which the oil recovered into the casing is directly supplied to the oil pump, without passing through another flow path, may be formed.

The oil recovery flow path may further include a cross flow path communicating with the direct flow path and formed in a direction intersecting the direct flow path. The pump housing may further include a recovery inlet formed to communicate between the oil recovery flow path and the pumping space, and a recovery guide groove formed in a circumferential direction on one surface of the subframe to guide oil flowing in from the oil recovery flow path to the recovery inlet.

According to embodiments disclosed herein, the scroll compressor may further include an oil recovery pipe having one or a first end coupled to the oil separator and the other or a second end coupled to the casing to provide the oil separated from the oil separator to the inside of the casing. The casing may be provided with an oil recovery hole to which the oil recovery pipe is coupled at the other end of the oil recovery pipe, and the first flow path may be connected to the oil recovery hole. The oil recovery flow path may be formed in an oblique direction.

Embodiments disclosed herein further provide a scroll compressor that may include a casing having an oil storage space, a suction pipe and a discharge pipe being connected to the casing; a drive motor installed in an inner space of the casing and including a rotational shaft rotated by a generated drive force; a compression unit installed in the inner space of the casing and having a compression chamber operated by the drive motor to compress refrigerant; an oil separator coupled to the discharge pipe, that receives refrigerant discharged after being compressed by the compression unit, separates oil, and supplies the separated oil to an inside of the casing; a subframe that rotatably supports the rotational shaft from one side of the rotational shaft; and an oil pump that recovers the oil separated from the oil separator, while operated by the rotational force of the rotational shaft, and pumps the oil filling the inner space of the casing to supply the oil to the oil flow path of the rotational shaft. The subframe may be provided with an oil recovery flow path provided in a radial direction and that guides oil to be recovered toward the inside of the casing from the oil separator. Due to the direct flow path formed to be parallel to the ground to directly provide the oil provided from the oil separator to the oil pump, an oil pump direct oil supply structure in which the oil recovered into the casing is directly supplied to the oil pump, without passing through another flow path, may be formed.

The subframe may be provided with a frame support portion (frame support) extending in a radial direction and coupled to and supported by an inner periphery of the casing. The oil recovery flow path may include a first flow path formed in the radial direction at the frame support portion and receiving oil provided from the oil separator; and a second flow path formed to intersect the first flow path allowing the oil provided from the first flow path to be provided to the oil pump. Accordingly, the scroll compressor according to embodiments may be manufactured through a simple process during mass-production as the oil recovery flow path is formed of first and second flow paths intersecting each other in the subframe.

The oil pump may include a pump housing coupled to one surface of the subframe and having a pumping space; an inner gear rotatably disposed in the pumping space of the pump housing and coupled to the rotational shaft for eccentric rotation; and an outer gear rotatably disposed in the pumping space to be engaged with the inner gear to change a volume of the pumping space. The oil recovery flow path may communicate with the pumping space.

The oil recovery flow path may include a direct flow path provided to be parallel with a ground to directly provide the oil provided from the oil separator to the pumping space. In addition, the oil recovery flow path may further include a cross flow path communicating with the direct flow path and formed in a direction intersecting the direct flow path.

According to according to an embodiment, a rib may protrude from one surface of the frame support portion. The rib may extend in a radial direction, and the first flow path may be provided in a radial direction inside of the rib.

One surface of the frame support portion may be coupled to the inner periphery of the casing, and the first flow path may penetrate through one surface of the frame support portion. The rib may protrude from an upper surface or a lower surface of the frame support portion.

Further scope of applicability of embodiments will become more apparent from the detailed description. However, it should be understood that the detailed description and specific examples, while indicating embodiments, are given by way of illustration only, as various changes and modifications within the spirit and scope will become apparent to those skilled in the art from the detailed description.

It will be apparent to those skilled in the art that embodiments may be embodied in other specific forms without departing from the spirit or essential characteristics thereof. The above detailed description should not be limitedly construed in all aspects and should be considered as illustrative. Therefore, all changes and modifications that fall within the metes and bounds of the claims, or equivalents of such metes and bounds are therefore intended to be embraced by the appended claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A scroll compressor, comprising:
a casing having an oil storage space, a suction pipe and a discharge pipe being connected to the casing;
a drive motor installed in an inner space of the casing and including a rotational shaft rotated by a generated drive force;
a compression unit installed in the inner space of the casing and having a compression chamber operated by the drive motor to compress a refrigerant;
an oil separator coupled to the discharge pipe, that receives refrigerant discharged after being compressed by the compression unit, separates oil from the refrigerant, and supplies the oil to an inside of the casing; and
a subframe that rotatably supports the rotational shaft at one side of the rotational shaft, wherein the subframe is provided with at least one frame support that extends in a radial direction and coupled to and supported by an inner periphery of the casing, and wherein the at least one frame support includes an oil recovery flow path that extends in the radial direction and guides oil to be recovered toward the inside of the casing from the oil separator.

2. The scroll compressor of claim 1, wherein the oil recovery flow path includes:
a first flow path that extends in the radial direction at the at least one frame support and receives oil provided from the oil separator; and
a second flow path that intersects the first flow path and having an outlet open toward the oil storage space to enable the oil provided from the first flow path to flow into the oil storage space.

3. The scroll compressor of claim 2, wherein one surface of the at least one frame support is coupled to the inner periphery of the casing, and the first flow path penetrates through the one surface of the at least one frame support.

4. The scroll compressor of claim 2, wherein a rib protrudes from one surface of the at least one frame support, the rib extends in the radial direction, and the first flow path extends in the radial direction inside of the rib.

5. The scroll compressor of claim 4, wherein the one surface from which the rib protrudes comprises an upper surface or a lower surface of the at least one frame support.

6. The scroll compressor of claim 1, further comprising:
an oil pump that recovers the oil separated from the oil separator, while being operated by the rotational force of the rotational shaft, and pumps the oil within the inner space of the casing to supply the oil to an oil flow path of the rotational shaft.

7. The scroll compressor of claim 6, wherein the oil pump includes:
a pump housing coupled to one surface of the subframe and having a pumping space;
an inner gear rotatably disposed in the pumping space of the pump housing and coupled to the rotational shaft for eccentric rotation; and
an outer gear rotatably disposed in the pumping space to be engaged with the inner gear to change a volume of the pumping space, wherein the oil recovery flow path communicates with the pumping space.

8. The scroll compressor of claim 7, wherein the oil recovery flow path includes a direct flow path that extends parallel to ground in the pumping space to directly provide the oil provided from the oil separator to the pumping space.

9. The scroll compressor of claim 8, wherein the oil recovery flow path further includes a cross flow path that communicates with the direct flow path and extends in a direction intersecting the direct flow path.

10. The scroll compressor of claim 7, wherein the pump housing further includes:
a recovery inlet that provides communication between the oil recovery flow path and the pumping space; and
a recovery guide groove formed in a circumferential direction on the one surface of the subframe to guide oil flowing in from the oil recovery flow path to the recovery inlet.

11. The scroll compressor of claim 4, further comprising:
an oil recovery pipe having a first end coupled to the oil separator and a second end coupled to the casing to provide the oil separated from the oil separator to the inside of the casing, wherein the casing is provided with an oil recovery hole to which the oil recovery pipe is coupled at the second end of the oil recovery pipe, and the first flow path is connected to the oil recovery hole.

12. The scroll compressor of claim 1, wherein the oil recovery flow path extends in an oblique direction.

13. A scroll compressor, comprising:
a casing having an oil storage space, a suction pipe and a discharge pipe being connected to the casing;
a drive motor installed in an inner space of the casing and including a rotational shaft rotated by a generated drive force;
a compression unit installed in the inner space of the casing and having a compression chamber operated by the drive motor to compress a refrigerant;
an oil separator coupled to the discharge pipe, that receives refrigerant discharged after being compressed by the compression unit, separates oil from the refrigerant, and supplies the oil to an inside of the casing;
a subframe that rotatably supports the rotational shaft at one side of the rotational shaft; and
an oil pump that recovers the oil separated from the oil separator, while being operated by the rotational force of the rotational shaft, and pumps the oil filling the inner space of the casing to supply the oil to an oil flow path of the rotational shaft, wherein the subframe includes an oil recovery flow path that extends in a radial direction and guides oil to be recovered toward the inside of the casing from the oil separator.

14. The scroll compressor of claim 13, wherein the subframe is provided with at least one frame support that extends in the radial direction and coupled to and supported by an inner periphery of the casing, and wherein the oil recovery flow path includes:
a first flow path that extends in the radial direction at the at least one frame support and receives oil provided from the oil separator; and
a second flow path that intersects the first flow path allowing the oil provided from the first flow path to be provided to the oil pump.

15. The scroll compressor of claim 14, wherein the oil pump includes:
a pump housing coupled to one surface of the subframe and having a pumping space;
an inner gear rotatably disposed in the pumping space of the pump housing and coupled to the rotational shaft for eccentric rotation; and
an outer gear rotatably disposed in the pumping space to be engaged with the inner gear to change a volume of the pumping space, wherein the oil recovery flow path communicates with the pumping space.

16. The scroll compressor of claim 13, wherein the oil recovery flow path includes a direct flow path that extends parallel to ground to directly provide the oil provided from the oil separator to the pumping space.

17. The scroll compressor of claim 16, wherein the oil recovery flow path further includes a cross flow path that communicates with the direct flow path and extends in a direction intersecting the direct flow path.

18. The scroll compressor of claim 14, wherein a rib protrudes from one surface of the frame support, the rib extends in a radial direction, and the first flow path is provided in the radial direction inside of the rib.

19. The scroll compressor of claim 18, wherein the one surface from which the rib protrudes comprises an upper surface or a lower surface of the at least one frame support.

20. The scroll compressor of claim 14, wherein one surface of the frame support is coupled to the inner periphery of the casing, and the first flow path penetrates through the one surface of the at least one frame support.

21. A scroll compressor, comprising:
a casing having an oil storage space, a suction pipe and a discharge pipe being connected to the casing;
a drive motor installed in an inner space of the casing and including a rotational shaft rotated by a generated drive force;
a compression unit installed in the inner space of the casing and having a compression chamber operated by the drive motor to compress a refrigerant;
an oil separator coupled to the discharge pipe, that receives refrigerant discharged after being compressed by the compression unit, separates oil from the refrigerant, and supplies the oil to an inside of the casing; and
a subframe that rotatably supports the rotational shaft at one side of the rotational shaft, wherein the subframe is provided with a plurality of frame supports that extends in a radial direction and coupled to and supported by an inner periphery of the casing, and wherein at least one of the plurality of frame supports includes a rib that protrudes from an upper or lower surface thereof and extends in the radial direction and an oil recovery flow path that extends in the radial direction through the rib and guides oil to be recovered toward the inside of the casing from the oil separator.
